(19) United States
(12) Patent Application Publication
(10) Pub. No.: US 2010/0305818 A1
(43) Pub. Date: Dec. 2, 2010

(54) METHOD AND CONTROL UNIT FOR ACTIVATING OCCUPANT PROTECTION MEANS, AS WELL AS COMPUTER PROGRAM AND COMPUTER PROGRAM PRODUCT

(76) Inventors: Alfons Doerr, Stuttgart (DE); Marcus Hiemer, Kehlen (DE)

Correspondence Address: KENYON & KENYON LLP, ONE BROADWAY, NEW YORK, NY, 10004, US

(21) Appl. No.: 12/599,626

(22) PCT Filed: May 16, 2008
(86) PCT No.: PCT/EP08/56055

§ 371 Date: Nov. 10, 2009

(30) Foreign Application Priority Data
Jun. 15, 2007 (DE) 10 2007 027 649.6

(51) Int. Cl. B60R 21/013

(52) U.S. Cl. 701/46; 701/45

(57) ABSTRACT

A control unit and a method for activating an occupant protection arrangement are described, a feature vector having at least two features being formed from at least one signal of a crash sensor system. The occupant protection arrangement is activated by a kernel algorithm as a function of the feature vector or a first partial feature vector. The feature vector or a second partial feature vector is classified by a support vector machine (SVM) and the kernel algorithm is influenced by the classification.

### FIELD OF THE INVENTION

The present invention relates to a method and a control unit for activating an occupant protection arrangement, as well as to a computer program and a computer program product.

### BACKGROUND INFORMATION

German patent document DE 103 60 893 A1 discusses activating an occupant protection arrangement as a function of a comparison of a forward displacement with a threshold value. The threshold value is set as a function of a velocity decrease and a deceleration. The velocity decrease and the deceleration span a two-dimensional feature space which is subdivided into two regions by the threshold value. These two regions characterize the classes that are significant for the activation of the occupant protection arrangement, the threshold value representing the lowest limit.

To automate a calibration process and to shorten the calibration time, automated learning-based methods are proposed. Neural networks are one possible implementation as discussed in WO 2005/037609 A1, WO 2005/037610 A1, WO 2005/037611 A1, WO 2005/035319 A1, EP 1133418, and DE 198 54 380 A1. In a training process, which takes place off line in the lab, the separating line otherwise calibrated manually is set automatically by the machine learning method. The algorithm ultimately delivers a triggering decision based on neural networks on the basis of a learned characteristic curve.

The use of such neural networks is non-transparent. There is no fall-back level in the case of an erroneous classification. In addition, neural networks require a large amount of training data, which often do not exist. The problem of so-called overfitting, which is an excessive specialization of neural networks, is disadvantageous.

### SUMMARY OF THE INVENTION

The method and control unit according to the present invention for activating the occupant protection arrangement have the advantage over the related art that a kernel algorithm known from the related art is combined with a classification method, so that the strengths of both methods complement each other. A support vector machine (SVM) is used here as the classifier. The SVM is trained in the lab. It delivers a multidimensional separating surface, for example, between a triggering region and a non-triggering region, and possibly, however, also between different crash classes such as ACT, ODB40 kmh, ODB64 kmh, 56 kFullFrontal, AngularCrash, etc. The comparison of crash data with the support vectors corresponding to the separating line, performed in actual operation, delivers a classification of the crash signal. This classification generates an influence on the kernel algorithm, so that its triggering performance is optimized.

This brings about a series of advantages:
1. By combining the kernel algorithm with the classification method, the interfaces are outwardly identical, i.e., the data acquisition by the sensors and the surroundings parameters such as, for example, the safety belt buckle, as well as the activation of the occupant protection arrangement, may take place according to the proven principle. An existing safety concept also does not have to be modified.
2. By combining the classification method with the kernel algorithm, there is a physically secured fall-back level, specifically for the case where the classification was unsuccessful.
3. The separating surface found via the SVM optimally subdivides the different crash classes. The separating line therefore has maximum sturdiness in view of the use of cost-effective hardware. Thus, for example, a simpler sensor system, having a lower resolution, may be used.
4. The optimum separating line or separating surface, i.e., separating functions, is always found. In other words, the objective of learning is always achieved. This is not the case with neural networks, for example. In the case of neural networks, the optimizing algorithm for determining the separating plane or separating surface may remain hung up at a local minimum. The quality of the separating function may thus be very poor under certain conditions. This problem does not exist due to the properties of the support vector optimization.
5. The classification is universally applicable. This is described more precisely in the dependent claims.
6. By using more than two dimensions, more crash information may be simultaneously combined. The quality of the classification is therefore improved.
7. Learning-based classifiers such as the SVM may be evaluated using objective quality indicators. The quantitative quality of the classifier may thus be made use of, so that it may be transferred to the quality of a calibration and expressed numerically.
8. Due to the automatic character of the calibration, calibration time may be saved, since the separating function is calculated automatically.
9. Due to the automatic character of the calibration, multiple numerical experiments may be performed, which would no longer be easy to interpret by the calibrator. By adding, for example, FEM simulation data or vehicle dynamics simulation data, the calibration may be extended, in a simple manner, beyond the previously used crash test site scenarios to real-world scenarios.
10. The separating function of the support vector machine replaces several additional functions. The selection of the correct additional function is time-consuming in the standard calibration process. This time is saved due to the proposed method.
11. Classification computation time is saved due to the flexible algorithm-based decision-making regarding activation; this time may then be used for other calculations, for example, for merging different additional functions.
12. The method according to the present invention makes it possible to reduce the run time, which also results in simpler and therefore more cost-effective hardware.
13. It is possible to respond to events during the crash in a more flexible manner, since some firing decisions do not occur until later.

The core of the present invention is the classification of the feature or the partial feature vector by a support vector machine. The kernel algorithm is then influenced by this classification. The support vector machine is based on a statistical learning process, which is described in greater detail below.

Triggering is understood here as activation of the occupant protection arrangement such as airbags, seatbelt tensioners, rollover bars, or also active occupant protection arrangements such as brakes or an electronic stability program.

A feature vector here contains at least two features which are formed from a signal of a crash sensor system. For example, if the signal is an acceleration signal, the acceleration signal itself or the first or second integral may be used as features. The vector is formed therefrom which is incorporated, on the one hand, in the kernel algorithm and, on the other hand, in the support vector machine. It is possible that only part of the feature vector is incorporated in the support vector machine. It is then referred to as a partial feature vector. This also applies to the reverse case, i.e., a feature vector is incorporated in the support vector machine, while only a partial feature vector is incorporated in the kernel algorithm.

The crash sensor system may be, in this case, an acceleration sensor system inside and/or outside the control unit, which is also true for a structure-borne noise sensor system.

Furthermore, the crash sensor system may have an air pressure sensor system on the lateral parts of the vehicle and also a surroundings sensor system. Other common crash sensors known to those skilled in the art may be included here. The signal may have one or more measured values of different sensors.

The kernel algorithm here is an algorithm which analyzes the feature vector in such a way that an activation decision may be made. This may take place via a threshold value decision, for example.

A classification here means that the feature vector is assigned to a certain class. This class then determines how the kernel algorithm is influenced. Classes may be divided, for example, by the severity of the crash, i.e., to what degree the crash affects the occupants. A classification by crash type or by a combination of crash type and crash severity may also be used.

The influence is described in greater detail in the dependent claims. Influence is exerted, in particular on the activation decision, i.e., the classification results, in a first case, in a triggering decision, which would not have been made without the influence of the classification.

A control unit is understood here as a device that decides on the activation of the occupant protection arrangement as a function of sensor signals. Therefore, the control unit has means for analyzing the signals of the crash sensor system. To issue the control signal, a suitable device in the control unit is then also needed.

The at least one interface is implemented here with the aid of hardware and/or software. As software, it is embodied, for example, as a software module on a microcontroller in the control unit.

The analyzer circuit is normally a microcontroller; however, it may also be another processor type such as a microprocessor or a signal processor. An integrated circuit which contains the analyzer functions and is embodied, for example, as an ASIC, may be used as the analyzer circuit. The analyzer circuit may also have discrete components or a combination of the above-mentioned subassemblies. It is also possible to form the analyzer circuit from a plurality of processors. For the individual functions, the analyzer circuit then has appropriate software modules when it is a processor type such as a microcontroller, or appropriate hardware modules are present which may also be situated on a single chip.

The measures and refinements recited in the dependent claims make advantageous improvements on the method for activating the occupant protection arrangement described in the independent claims possible.

It is advantageous that the kernel algorithm forms a decision for the activation by comparing the feature vector to a first threshold value in an at least two-dimensional feature space. The kernel algorithm is thus designed in such a way that it transfers the feature vector having the at least two features into an at least two-dimensional feature space and compares it there to a threshold value, where the threshold value may also be a function. A time-invariable kernel algorithm is thus implemented, where, for example, the deceleration and the first integral of the deceleration, i.e., the velocity, may be used as the features. However, other variables such as forward displacement, i.e., the double integral of the deceleration, may also be used here.

It is furthermore advantageous that the kernel algorithm is influenced by the classification in that the first threshold value is modified as a function of the classification. By modifying this threshold value, the classification directly affects the decision-making of whether or not the occupant protection arrangement are to be activated. This modification may take place via an addition or subtraction as a function of the classification or by replacing the first threshold value with a second threshold value. The second threshold value is stored in a memory, for example, or is calculated.

It is furthermore possible to perform a plausibility check of the activation decision as a function of the classification in addition to influencing the kernel algorithm. Using the classification, a decision is made as to whether or not a case of triggering the occupant protection arrangement exists. This result is then combined with the decision of the kernel algorithm to reach a reliable overall decision. Additional functions may also contribute to the combination. These additional functions include, for example, the processing of further sensor signals or a crash type recognition.

Plausibility check means that a first decision is confirmed or revoked by a second decision. This makes a more reliable overall decision possible.

It is furthermore advantageous that a misuse is recognized as a function of the classification, and the kernel algorithm takes this into account in the activation. A misuse is an impact which should not result in the occupant protection arrangement being triggered. A triggering decision by the kernel algorithm may thus still be prevented. This may also be determined as a function of the particular classification. The classification may also be used as a supplement to an existing misuse classification. Also in this case, the classification may provide an add-on to the shift of a misuse threshold or act as a misuse plausibility check function, for example.

It is furthermore advantageous that a very severe crash is recognized as a function of the classification. A very severe crash usually must activate all necessary front occupant protection arrangements, i.e., the seatbelt tensioner and the first and second airbag stages. If the kernel algorithm classifies activation and the SVM classifies a very severe crash, the SVM classification may cause all front occupant protection arrangements to be activated by an activation circuit.

It is furthermore advantageous that there is a computer program which executes all steps of the method according to the present invention as recited in one of claims 1 through 7 when it runs on a control unit. This computer program may be originally written in high-level computer language and is then translated into a machine-readable code.

Also advantageous is a computer program product in the program code, which is stored on a machine-readable medium, such as a semiconductor memory, a hard disk memory, or an optical memory, and is used for carrying out the method as recited in one of claims 1 through 7 when the program is executed on a control unit.

Exemplary embodiments of the present invention are depicted in the drawing and explained in greater detail in the description that follows.

### BRIEF DESCRIPTION OF THE DRAWINGS

FIG. 1 shows a block diagram of the control unit according to the present invention having connected components.

FIG. 2 shows different software modules on the microcontroller.

FIG. 3 shows a first flow chart of the method according to the present invention.

FIG. 4 shows a first signal variation diagram.

FIG. 5 shows a second signal variation diagram.

FIG. 6 shows a third signal variation diagram.

FIG. 7 shows a fourth signal variation diagram.

FIG. 8 shows a separation line between two classes in the SVM.

FIG. 9 shows a separation line in the initial space.

FIG. 10 shows a separation line in the image space.

FIG. 11 shows a diagram for elucidating the training procedure by applying input and output data in a targeted manner.

### DETAILED DESCRIPTION

An aspect of the exemplary embodiments and/or exemplary methods of the present invention is the use of the support vector machine (SVM) as the classifier of the feature vector. This is to be elucidated in greater detail in the following.

In the following, the classification principle of the SVM is to be described for two classes, for example, for separating fire crashes and no-fire crashes. In principle, this may be applied easily to the classification of multiple classes.

A precise description of the SVM may be encountered in the relevant literature (for example, Nello Cristianini, and John Shawe-Taylor: An introduction to support vector machines and other kernel-based learning methods or Trevor Hastie: The elements of statistical learning).

Multiclass support vector classification is described, for example, in Bernhard Schölkopf et al.: Extracting Support Data for a Given Task, Proceedings of the First International Conference on Knowledge Discovery and Data Mining, AAAI Press, Menlo Park, Calif., 1995, pp. 252-257.

Only the principle will be qualitatively described here.

### Linear Separation

The support vector machine is a linear classifier. The linear separation line has the following aspect:

f(x)=w·x+b (1)

The purpose is to draw a separation line between the two classes to be classified that is optimum regarding the distance of the training data (FIG. 8). This is solid line 84 in FIG. 8. While the two finer separating lines 80, 81 also separate, they do not do so optimally regarding sturdiness. Only separating line 84 provides maximum sturdiness and allows the use of simpler and therefore more cost-effective hardware as described in point 3 of “Advantages of the Invention.”

Finding the optimum straight lines for separating the classes is known as a “quadratic problem with linear boundary conditions.” A quadratic problem with linear boundary conditions may be solved efficiently by using algorithms of the quadratic programming (point 3 of “Advantages of the Invention”). (See, for example, “R. Vanderbei, LOQO: An Interior Point Code for Quadratic Programming”.) An important advantage is the fact that this optimum solution is always found by the algorithms. Therefore, there is no risk of remaining hung up at a local minimum of the optimization (point 4 of “Advantages of the Invention”). The characteristic curve shown in FIG. 8 is the result of the optimization.

In mathematics, equation (1) may be represented in the so-called “dual form”:

$$f ( x ) = {\sum }_{i = 1}^{1} {y}_{i} {α}_{i} \cdot {x}_{i} \cdot x + b \qquad ( 2 )$$

The two representations are identical. yᵢ is the class to which training data i belong (usually +1 or −1); xᵢ represents the so-called support vectors; x are, for example, the features to be classified in the crash. In FIG. 8, the support vectors may be recognized as those features that lie on dashed lines 82, 83. They represent those support vectors that lie “the closest to the other class.” When considering equation (2), factors αᵢ, the so-called Lagrange multipliers, have not yet been discussed. Factors αᵢ are different from zero only for the support vectors. In other words, this means that equation (2) must only be analyzed for the support vectors. Even more graphically: New features arising, for example, during the crash no longer need to be analyzed with respect to the entire solid separating line 84 shown in FIG. 8, but only with respect to the support vectors on dashed straight lines 82, 83. The number of support vectors may be kept low by using the method, and thus the complexity of the calculations in the ECU may be limited.

In summary, it may therefore be stated: The support vector algorithm, which is run through during the training, always finds an optimum, i.e., maximally sturdy, separating line of the two classes. After the training, in the test or in the crash, the generated features are not analyzed with respect to the entire separating line, but only with respect to the (much fewer) support vectors.

### Non-linear Separation

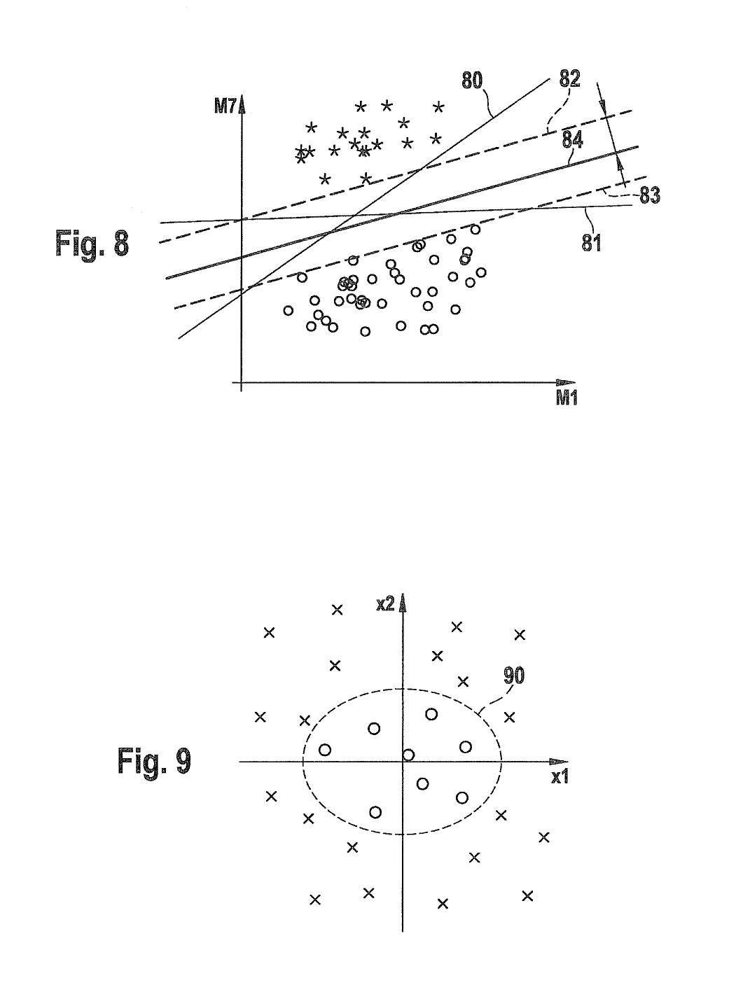

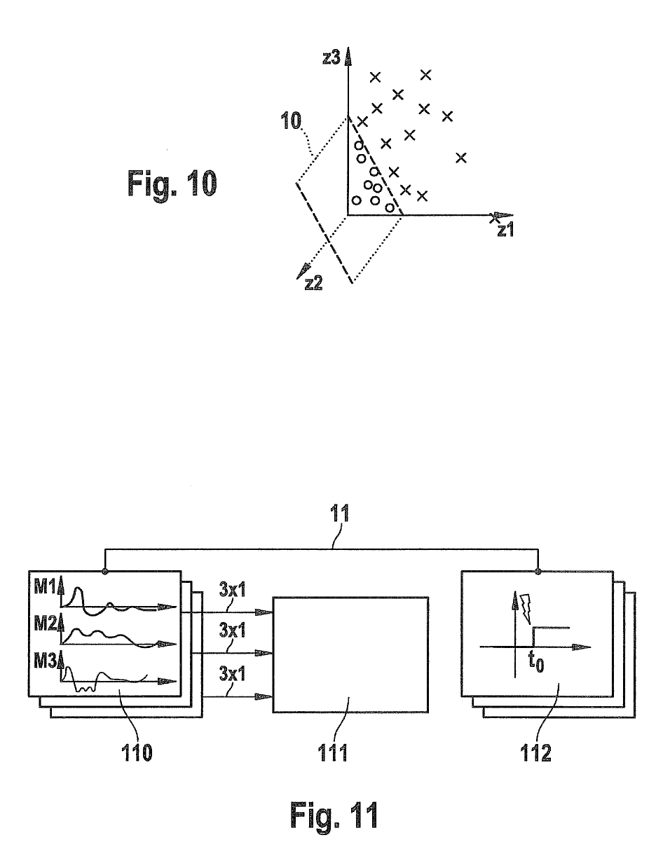

In reality, the classes are normally not linearly separable, but are separable only by a non-linear separating line. The so-called “kernel trick” is used for this reason. From the initial space (x1, x2) in FIG. 9, which is described by two of the three features 1 . . . 3 from FIG. 7, the so-called image space (z1, z2, z3) in FIG. 10 is reached via a suitable transformation with the help of a kernel. Reference numeral 90 identifies the non-linear separating line in the initial space in FIG. 9 and reference numeral 10 identifies the corresponding linear separating line in FIG. 10.

In the image space, the features are linearly separable again (see FIGS. 9 and 10), and equation 2 may be used again: the algorithm for finding the optimum linear separating line in the image space, which always converges optimally. The kernel trick has the following advantage: The transformation into the image space does not take place explicitly, i.e., calculations are not actually performed in the image space. Only the mathematical “kernel function” is used for achieving linear separability in the image space. However, any calculation is performed as previously in the initial space. Equation (2) then becomes for the non-linear case:

$$f ( x ) = {\sum }_{i = 1}^{1} {y}_{i} {α}_{i} \cdot k ( {x}_{i} , x ) + b \qquad ( 3 )$$

The kernel function k(xᵢ, x) must meet certain mathematical conditions, which may be found, for example, in Nello Cristianini and John Shawe-Taylor: “An introduction to support vector machines and other kernel-based learning methods.” Normally the following standard kernels are used as kernel functions:
radial base kernel,
polynomial kernel,
sigmoidal kernel,
. . . .

It should be pointed out that the exemplary embodiments and/or exemplary methods of the present invention does not depend on the kernel function.

As is readily apparent from equation (3), the normally non-linear kernel function k(xᵢ, x) must also be calculated exclusively for the support vectors. For the example of a radial base kernel

$$k ( {x}_{i} , x ) = exp ( - \frac{{‖ {x}_{i} - x ‖}^{2}}{σ} ) \qquad ( 4 )$$

this means: the distance of features x must only be calculated for the support vectors xᵢ. The e-function could be saved in the control unit, for example, via a Taylor approximation, or implemented by a lookup table. Parameter δ in equation (4) allows the sturdiness of the classifier and thus the number of support vectors to be influenced.

In summary, it may thus be stated that by using the kernel trick, even non-linear characteristic curves may be optimally separated without need for performing the transformation explicitly in the image space. The kernel function and formula (3) for separating must be analyzed only with regard to the support vectors.

### Slack Variable

By using so-called slack variables, the sturdiness of the classification may be further enhanced. Erroneous classifications are occasionally tolerated with the help of the slack variables. For this purpose, erroneously classified features are added up weighted using a factor C:

$$G = C \cdot {\sum }_{∀ i} {ξ}_{i} . \qquad ( 5 )$$

Since it may be advantageous to penalize the erroneous classification of one class more severely than that of another class (for example, it may be tolerated that a must-fire is classified as no-fire, rather than the other way around), equation (5) should be extended:

$$G = {C}_{\{ + 1 \}} \cdot {\sum }_{∀ i ∈ \{ + 1 \}} {ξ}_{i} + {C}_{\{ - 1 \}} \cdot {\sum }_{∀ i ∈ \{ - 1 \}} {ξ}_{i} with {C}_{\{ - 1 \}} 〉 〉 {C}_{\{ + 1 \}} . \qquad ( 6 )$$

Equation (6) has the effect that erroneous classification of class −1 (i.e., “no fire,” for example) has a higher weight than that of class +1 (“must fire”). Allowing erroneous classifications may also affect the number of support vectors and thus indirectly the calculation time. When using slack variables, the calibrator may still introduce, a priori, his knowledge about his data. If he is aware of the fact that the data are highly scattered, erroneous classifications may be tolerable.

### Training

As in all learning-based methods, also in the case of the support vector machine, a training phase takes place prior to the actual use of the control unit (see FIG. 11). This takes place off-line. It is used to determine the support vectors which are then saved in the control unit. During training, input data 110 and output data 112 are supplied to classifier 111 in pairs. The three features from FIG. 7 may be used as input data. The desired trigger times may be used as output data. Attention must be paid to the fact that a balanced crash set is used during training and the usual sturdiness criteria such as amplitude variations and offset variations are taken into account to a reasonable degree.

The support vectors ascertained during training must subsequently be placed into the control unit.

### Validation

Often, in particular in an early airbag project phase, insufficient crash data are available. The training set may be increased and the reliability of the classification may be enhanced via cross-validation methods. In cross-validation, the available crash set is subdivided into subsets. Some subsets are used as training data; others are used to evaluate the classification quality. The best-known of these methods is probably the leave-one-out cross-validation, in which one data set is always used for the test and in which all other data sets have been drawn in advance for the training. If this one test data set is permutated through all the data sets, a very large number of tests is obtained for the classification and, using statistical analysis, the quality indicators described in point 7 of “Advantages of the Invention” may be determined for the classifier. With the help of cross-validation, the classification parameters, for example, δ in equation (4), may be further optimized on the basis of the quality indicators.

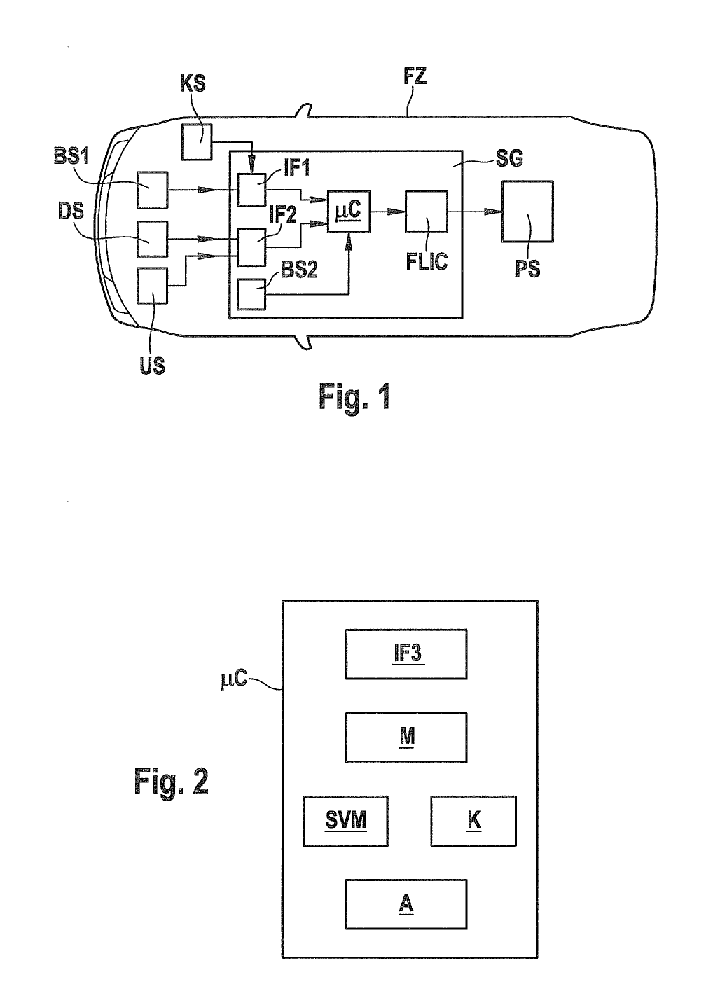

FIG. 1 shows, in a block diagram, control unit SG according to the present invention having connected components. Control unit SG, to which various components are connected, is situated in a vehicle FZ. Only the components necessary for the understanding of the present invention are shown here as an example both outside and inside the control unit.

Various crash sensors are connected to control unit SG, such as a structure-borne noise sensor system KS, an acceleration sensor system BS1, a pressure sensor system DS, and a surroundings sensor system US. Further sensors such as a vehicle dynamics sensor system and/or yaw rate sensors may be additionally or alternatively connected. Those skilled in the art are aware of different positions for installation in vehicle FZ. The structure-borne noise sensor system and acceleration sensor system BS1 are connected to a first interface IF1, interface IF1 providing these signals to the analyzer circuit, namely to microcontroller μC. A second interface IF2, to which air pressure sensor system DS and surroundings sensor system US are connected, provides these signals to microcontroller μC.

Air pressure sensor system DS is installed in the lateral parts of the vehicle and is to be used as a side impact sensor. Surroundings sensor system US may include different surroundings sensors such as radar, LIDAR, video, or ultrasound to analyze the surroundings of vehicle FZ regarding collision objects. Microcontroller pC receives further sensor signals from an acceleration sensor system BS2 within control unit SG. Further sensors may be located within the control unit and may output signals to microcontroller μC. These include vehicle dynamics sensors and structure-borne noise sensors.

Control unit SG here has a housing which may be made of metal and/or plastic. Microcontroller μC itself has internal memories, but may also access external memories also located in control unit SG. Using a kernel algorithm, microcontroller pC analyzes a feature vector from the features of these crash signals and decides whether the occupant protection arrangement PS, activated via activating circuit FLIC, are to be activated. For this purpose, the kernel algorithm is influenced by a support vector machine using a classification of the feature vector. Due to this influence, the decision is more accurate and more appropriate.

More or fewer than the illustrated sensors may be used. The communication of interfaces IF1 and IF2 to microcontroller pC may take place, for example, via bus SPI (serial peripheral interface bus) situated in the control unit. The SPI bus may also be used for the communication between microcontroller μC and activating circuit FLIC. Activating circuit FLIC here has a plurality of integrated circuits, which have power switches and, in the case of activation, make it possible to energize the firing or activating elements of the occupant protection arrangement PS. This activating circuit may also have different designs which have one or more integrated circuits and/or discrete components.

FIG. 2 shows software modules which are necessary for the function of the present invention and are located on the analyzer circuit, here in microcontroller μC. Microcontroller μC usually has its own memory.

However, it may also be a memory connected to microcontroller μC via conductors. An interface IF3 is used for connecting acceleration sensor system BS2 and provides the signals of this acceleration sensor system BS2. These signals are received, on the one hand, by feature module M, which forms features from the signals of the crash sensor system and forms the feature vector from the features by, for example, the acceleration signal being the signal and module M determining the velocity therefrom via simple integration and then forming a two-dimensional feature vector from the acceleration and the velocity.

This feature vector, which may also have a plurality of dimensions depending on the number of features it is to contain, is then incorporated, on the one hand, in module SVM which contains the support vector machine, and, on the other hand, in kernel algorithm K. It is possible that feature module M provides only one partial vector to module SVM, since only part of the features is needed for the classification. The same is true for the kernel algorithm. Module SVM now classifies the feature vector using the support vector machine. This classification result is also provided in kernel algorithm K. It is possible that this classification result may also be provided to other modules not illustrated here. For example, this classification result may be used as plausibility for a triggering decision obtained from another algorithm part. It is also conceivable that the classification result is used for controlling the further algorithm processing. For example, targeted turning on and off of functionality is conceivable. The kernel algorithm, together with the classification result, now influences the analysis of the feature module of whether or not the occupant protection arrangement PS is to be activated. If a decision is made that the occupant protection arrangement are to be activated, module A is activated for this purpose to generate an activation signal using the hardware of microcontroller μC and transmit it to activation circuit FLIC. This transmission may be secure in particular if it is done over the SPI bus.

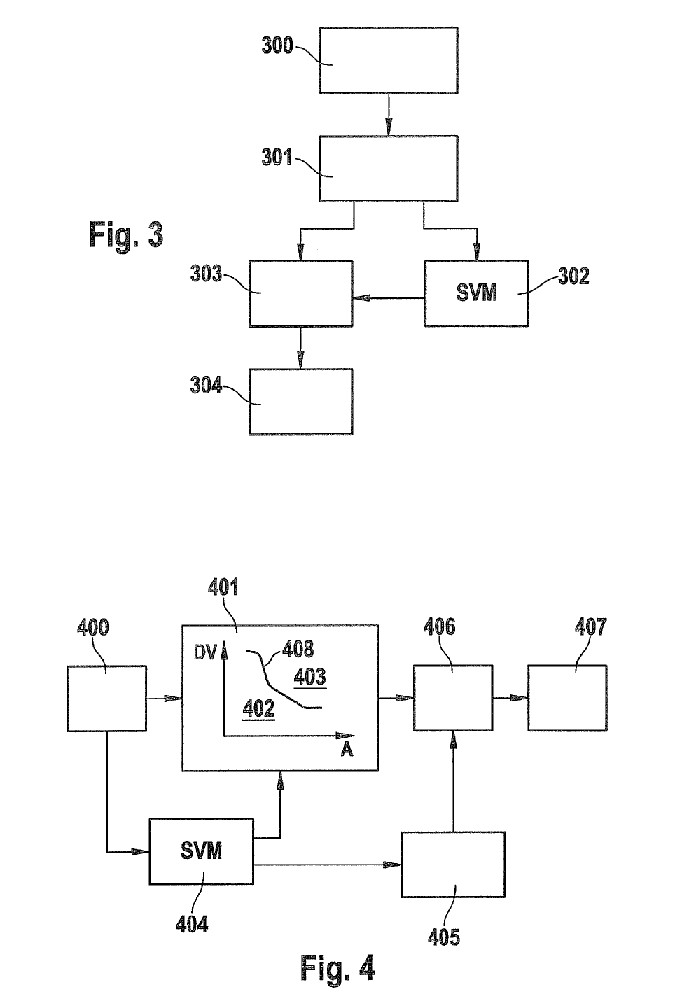

FIG. 3 explains the method according to the present invention in a first flow chart. In method step 300, the signal of the crash sensor system, the surroundings sensor system, and/or the vehicle dynamics sensor system is provided, via interfaces IF1, IF2, and IF3, respectively. In method step 301, the feature vector is formed therefrom as described above. This feature vector is supplied, in its entirety, to kernel algorithm 303 and in its entirety or partially to support vector machine 302. The support vector machine classifies the feature vector or the partial feature vector and transmits this classification result to kernel algorithm 303. Kernel algorithm 303 decides on the activation of occupant protection arrangement PS as a function of the feature vector and the classification result. Activation then takes place in method step 304.

FIG. 4 shows another signal variation diagram. The feature vector is provided in block 400 and provided to kernel algorithm 401, which spans a two-dimensional decision space, here made up of acceleration or deceleration A and velocity DV, A being plotted on the abscissa and DV on the ordinate. Threshold value 408 separates triggering case 403 from non-triggering case 402. The feature vector is entered in this decision space and a check is made of whether the feature vector is above or below threshold value 408, depending on which the output, that activation is to take place, is supplied to block 406. At the same time, feature vector 400 is provided to support vector machine SVM in block 404, the support vector machine performing the classification. This classification affects threshold value 408, for example. However, a plausibility check may also be performed from the classification in block 405, i.e., a check is made of whether the classification also indicates that a triggering case is present. The results of the plausibility check and of kernel algorithm 401 are linked in block 406. If this linking indicates an activation case, activation then takes place in block 407.

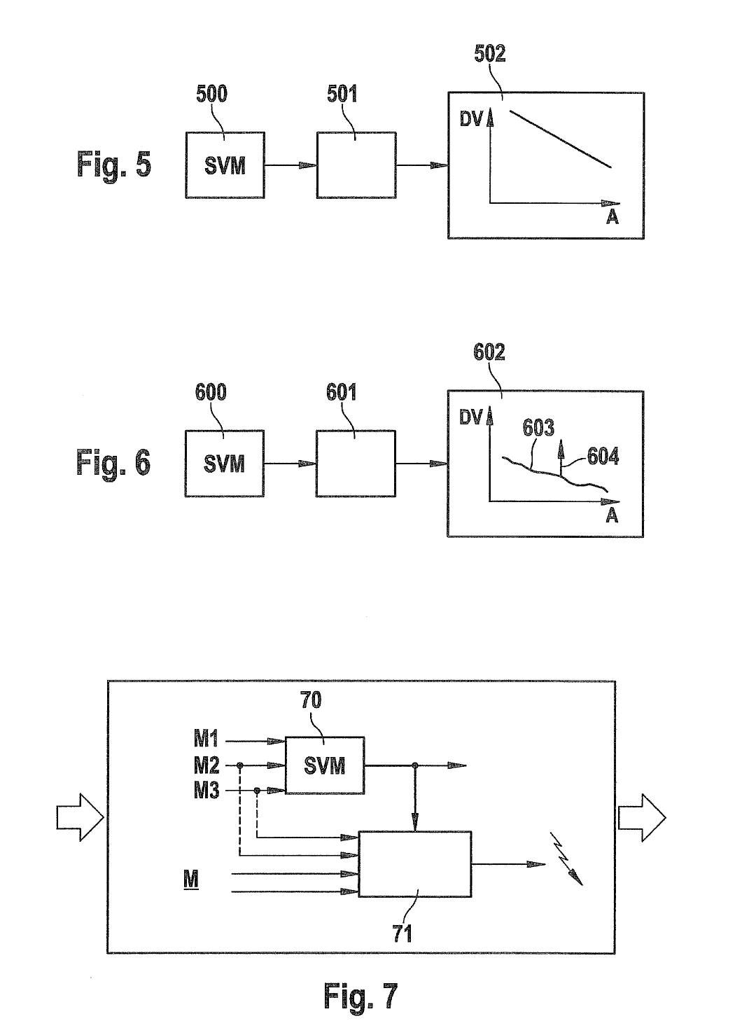

FIG. 5 shows another signal variation diagram. Only a section is shown here. Support vector machine 500 provides its classification to a search algorithm 501 which looks in a lookup table for a threshold value as a function of the classification, loads it, and provides it to kernel algorithm 502.

FIG. 6 shows another section of the signal variation diagram. The support vector machine again classifies the feature vector. This results in block 601 in an addition or subtraction for the threshold value, which is supplied to kernel algorithm 602, so that addition 604 to threshold value 603 is performed here.

FIG. 7 shows a signal variation diagram of the method according to the present invention. Features M1-3, which have been generated from the signal(s) of the crash sensor system, are supplied to support vector machine 70 for classification of the feature vector formed from features M1-3. These features M1-3 or a subset of features M1-3 and possibly other features, also from different sensors, are supplied to kernel algorithm 71, which makes the activation decision as a function of all these features. However, this activation decision is also influenced by the classification by support vector machine 70. The influence takes place, for example, by modifying the threshold value as a function of the classification. A particular class may result in a predefined addition or subtraction, or a particular threshold value is loaded for a particular class.

Additionally or alternatively, a separate plausibility check may also be performed from the classification, the result of this plausibility check and the decision of the kernel algorithm then being linked for making the ultimate activation decision.

1-11. (canceled)

12. A method for activating an occupant protection arrangement, the method comprising:
forming a feature vector, having at least two features, from at least one signal of a crash sensor system; and
activating the occupant protection arrangement by a kernel algorithm as a function of one of the feature vector and a first partial feature vector;
wherein the one of the feature vector and the second partial feature vector is classified by a support vector machine, and wherein the kernel algorithm is influenced by the classification.

13. The method of claim 12, wherein the kernel algorithm forms a decision for the activation by comparing the one of the feature vector and the first partial feature vector to a first threshold value in an at least two-dimensional feature space.

14. The method of claim 13, wherein the kernel algorithm is influenced by the classification in that the first threshold value is modified as a function of the classification.

15. The method of claim 14, wherein the modification of the first threshold value takes place via one of an addition, a subtraction, and by replacing the first threshold value with a second threshold value.

16. The method of claim 12, wherein a plausibility check of an activation is carried out as a function of the classification, and wherein the kernel algorithm takes into account the plausibility check in the activation.

17. The method of claim 12, wherein a misuse is recognized as a function of the classification and the kernel algorithm takes this into account in the activation.

18. The method of claim 12, wherein a very severe crash is recognized as a function of the classification.

19. The method of claim 18, wherein the support vector machine allows erroneous classifications, and the erroneous classifications of different classes receive different weights.

20. A control unit for activating an occupant protection arrangement, comprising:
at least one interface to provide at least one signal of a crash sensor system; and
an analyzer circuit which forms a feature vector having at least two features from the at least one signal;
wherein the analyzer circuit has a kernel algorithm which activates the occupant protection arrangement as a function of one of the feature vector and of a first partial feature vector, and
wherein the analyzer circuit has a support vector machine which classifies the one of the feature vector and of a second partial feature vector, and influences the kernel algorithm as a function of the classification.

21. A computer readable medium having a computer program, which is executable by a processor of a control unit, comprising:
a computer code arrangement having computer program code for activating an occupant protection arrangement, by performing the following:
forming a feature vector, having at least two features, from at least one signal of a crash sensor system; and
activating the occupant protection arrangement by a kernel algorithm as a function of one of the feature vector and a first partial feature vector;
wherein the one of the feature vector and the second partial feature vector is classified by a support vector machine, and wherein the kernel algorithm is influenced by the classification.

22. A control unit for activating an occupant protection arrangement, comprising:
a vector arrangement to form a feature vector, having at least two features, from at least one signal of a crash sensor system; and
an activating arrangement to activate the occupant protection arrangement by a kernel algorithm as a function of one of the feature vector and a first partial feature vector;
wherein the one of the feature vector and the second partial feature vector is classified by a support vector machine, and wherein the kernel algorithm is influenced by the classification.
